(19) United States
(12) Patent Application Publication
(10) Pub. No.: US 2023/0131138 A1
(43) Pub. Date: Apr. 27, 2023

(54) MULTI-PHASE INDUCTOR STRUCTURE

(71) Applicant: MAG.LAYERS SCIENTIFIC-TECHNICS CO.,LTD., Taoyuan City (TW)

(72) Inventors: HUNG-CHIH LIANG, TAOYUAN CITY (TW); PIN-YU CHEN, TAOYUAN CITY (TW); HSIU-FA YEH, TAOYUAN CITY (TW); HANG-CHUN LU, TAOYUAN CITY (TW); YA-WAN YANG, TAOYUAN CITY (TW); YU-TING HSU, TAOYUAN CITY (TW); WEI-ZHI HUANG, TAOYUAN CITY (TW)

(21) Appl. No.: 17/694,095

(22) Filed: Mar. 14, 2022

(30) Foreign Application Priority Data
Oct. 21, 2021 (TW) 110138979

(51) Int. Cl. H01F 27/255; H01F 27/26

(52) U.S. Cl. CPC H01F 27/255; H01F 27/266

(57) ABSTRACT

A multi-phase inductor structure is provided. The multi-phase inductor structure includes a first magnetic core, two second magnetic cores, and two first electrical conductors. The two second magnetic cores are respectively arranged on opposite sides of the first magnetic core, and each have a first engagement surface. A first annular convex wall and a first upright convex wall are formed on the first engagement surface, and a first recess is formed therebetween. The two first electrical conductors are respectively arranged in two of the first recesses of the first engagement surface, and each have has a first body and two first pins that are respectively connected to two ends of the first body. The two first pins extend in opposite directions. A magnetic permeability of the first magnetic core is different from a magnetic permeability of each of the two second magnetic cores.

### CROSS-REFERENCE TO RELATED PATENT APPLICATION

This application claims the benefit of priority to Taiwan Patent Application No. 110138979, filed on Oct. 21, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inductor structure, and more particularly to a multi-phase inductor structure.

### BACKGROUND OF THE DISCLOSURE

A single material is usually used as a magnetic core in conventional inductor structures. However, inherent properties of different materials often result in deterioration of performance. For example, inductor structures that generate higher inductance values often cannot carry sufficient saturation current, or inductor structures that carry more saturation current often cannot generate higher inductance values.

On the other hand, a current trend of miniaturization and high-powered design of electronic circuit elements has led to an emergence of multi-phase inductor structures. However, multiple single-phase inductors are usually assembled in conventional multi-phase inductors, resulting in an increase in overall volume of the multi-phase inductor, so that a demand for product miniaturization cannot be met.

Therefore, how to improve a structural design, so as to design a miniaturized multi-phase inductor structure having high power to overcome the above issues has become one of the important issues to be addressed in the related field.

### SUMMARY OF THE DISCLOSURE

In response to the above-referenced technical inadequacies, the present disclosure provides a multi-phase inductor structure.

In one aspect, the present disclosure provides a multi-phase inductor structure, which includes a first magnetic core, two second magnetic cores, and two first electrical conductors. The two second magnetic cores are respectively arranged on two sides of the first magnetic core that are opposite to each other. Each of the two second magnetic cores has a first engagement surface, the first engagement surface has a first annular convex wall and a first upright convex wall formed thereon, and a first recess is formed between the first annular convex wall and the first upright convex wall. The two first electrical conductors are respectively arranged in two of the first recesses of the first engagement surface. Each of the two first electrical conductors has a first body and two first pins that are respectively connected to two ends of the first body, and the two first pins extend in opposite directions. A magnetic permeability of the first magnetic core is different from a magnetic permeability of each of the two second magnetic cores.

In another aspect, the present disclosure provides a multi-phase inductor structure, which includes two first magnetic cores, a second magnetic cores, and two first electrical conductors. The second magnetic core is arranged between the two first magnetic cores. The second magnetic core has two first engagement surfaces that are opposite to each other, each of the two first engagement surfaces has a first annular convex wall and a first upright convex wall formed thereon, and a first recess is formed between the first annular convex wall and the first upright convex wall. The two first electrical conductors are respectively arranged in two of the first recesses of the first engagement surface. Each of the two first electrical conductors has a first body and two first pins that are respectively connected to two ends of the first body, and the two first pins extend in opposite directions. A magnetic permeability of each of the two first magnetic cores is different from a magnetic permeability of the second magnetic core.

In yet another aspect, the present disclosure provides a multi-phase inductor structure, which includes a plurality of first magnetic cores, a plurality of second magnetic cores, a third magnetic core, and a plurality of electrical conductors. The plurality of second magnetic cores are arranged staggeringly with the plurality of first magnetic cores. Each of the plurality of second magnetic cores is arranged between two of the plurality of first magnetic cores that are adjacent to each other. Each of the plurality of second magnetic cores has two first engagement surfaces that are opposite to each other, each of the two first engagement surfaces has a first annular convex wall and a first upright convex wall, and a first recess is formed between the first annular convex wall and the first upright convex wall. The third magnetic core is in contact with one of two outermost first magnetic cores. The third magnetic core has a second engagement surface, the second engagement surface has a second annular convex wall and a second upright convex wall formed thereon, and a second recess is formed between the second annular convex wall and the second upright convex wall. The plurality of electrical conductors are correspondingly arranged in multiple ones of the first recesses of the first engagement surface and the second recess. Each of the plurality of electrical conductors has a body and two pins that are respectively connected to two ends of the body, and the two pins extend in opposite directions. A magnetic permeability of each of the plurality of first magnetic cores is correspondingly different from a magnetic permeability of each of the plurality of second magnetic cores and a magnetic permeability of the third magnetic core.

Therefore, one of the beneficial effects of the present disclosure is that, in the multi-phase inductor structure provided by the present disclosure, by virtue of “the plurality of first magnetic cores and the plurality of second magnetic cores are staggeringly arranged with each other” and “the magnetic permeability of the first magnetic core being different from the magnetic permeability of the second magnetic core,” the multi-phase inductor structure can have a miniaturized design with high power, and a capacitance value and current capability of the multi-phase inductor structure can be increased.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded view of a multi-phase inductor structure according to a first embodiment of the present disclosure;

FIG. 2 is a schematic perspective view of the multi-phase inductor structure according to the first embodiment of the present disclosure;

FIG. 3 is a schematic exploded view of a multi-phase inductor structure according to a second embodiment of the present disclosure;

FIG. 4 is a schematic perspective view of the multi-phase inductor structure according to the second embodiment of the present disclosure;

FIG. 5 is a schematic exploded view of a multi-phase inductor structure according to a third embodiment of the present disclosure;

FIG. 6 is a schematic perspective view of the multi-phase inductor structure according to the third embodiment of the present disclosure;

FIG. 7 is a schematic exploded view of a multi-phase inductor structure according to a fourth embodiment of the present disclosure;

FIG. 8 is a schematic perspective view of the multi-phase inductor structure according to the fourth embodiment of the present disclosure; and

FIG. 9 is a curve diagram showing characteristics of the multi-phase inductor structure according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

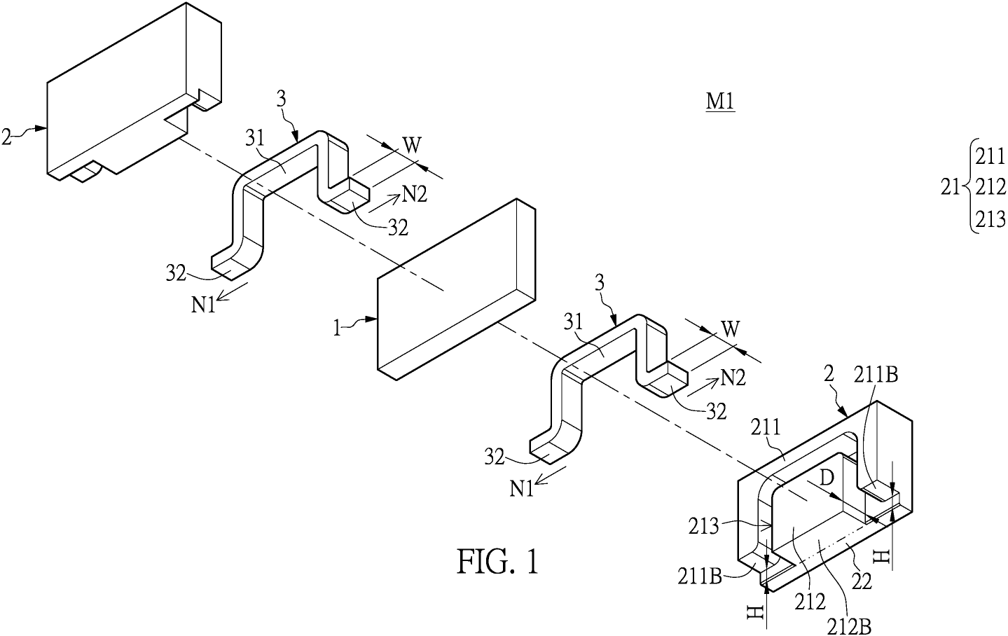

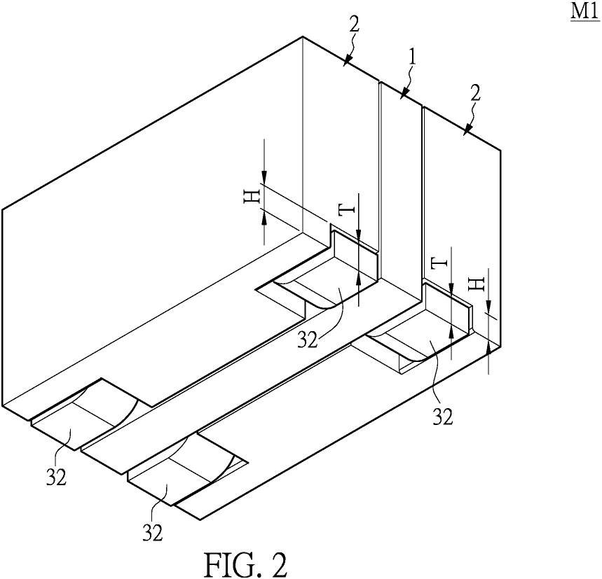

Referring to FIG. 1 and FIG. 2, FIG. 1 is a schematic exploded view of a multi-phase inductor structure according to a first embodiment of the present disclosure, and FIG. 2 is a schematic perspective view of the multi-phase inductor structure according to the first embodiment of the present disclosure. The first embodiment of the present disclosure provides a multi-phase inductor structure M1, which includes a first magnetic core 1, two second magnetic cores 2, and two first electrical conductors 3. The two second magnetic cores 2 are respectively arranged on two sides of the first magnetic core 1 that are opposite to each other. Each of the two first electrical conductors 3 is arranged between the first magnetic core 1 and a corresponding one of the two second magnetic cores 2, that is, one of the two first electrical conductors 3 is arranged between the first magnetic core 1 and a left one of the two second magnetic cores 2, and another of the two first electrical conductors 3 is arranged between the first magnetic core 1 and a right one of the two second magnetic cores 2. Each of the two second magnetic cores 2 has a first engagement surface 21. When the first magnetic core 1, the two second magnetic cores 2, and the two first electrical conductors 3, are assembled in the multi-phase inductor structure M1, the first engagement surface 21 of each of the second magnetic cores 2 comes into contact with the first magnetic core 1. It is worth mentioning that, a magnetic permeability of the first magnetic core 1 is different from a magnetic permeability of each of the two second magnetic cores 2. For example, the first magnetic core 1 is made of a ferrite material, the second magnetic core 2 is made of an alloy material, and the magnetic permeability of the first magnetic core 1 is greater than the magnetic permeability of the second magnetic core 2, but the present disclosure is not limited thereto. In other embodiments, the first magnetic core 1 is made of the alloy material, the second magnetic core 2 is made of the ferrite material, and the magnetic permeability of the first magnetic core 1 is less than the magnetic permeability of the magnetic core 2.

According to the above, each of the two first electrical conductors 3 has a first body 31 and two first pins 32 that are respectively connected to two ends of the first body 31, and the two first pins 32 extend in opposite directions. Specifically, as shown in FIG. 1, the first body 31 is an inverted U-shaped structure, one of the two first pins 32 extends in a first direction N1, another of the two first pins 32 extends in a second direction N2, and the first direction N1 is opposite to the second direction N2.

Further, the first engagement surface 21 of each of the two second magnetic cores 2 has a first annular convex wall 211 and a first upright convex wall 212 formed thereon, and a first recess 213 is formed between the first annular convex wall 211 and the first upright convex wall 212. As shown in FIG. 1, the first annular convex wall 211 is arranged around the first upright convex wall 212, so that the first recess 213 formed between the first annular convex wall 211 and the first upright convex wall 212 also has an inverted U-shaped profile, which corresponds to the first body 31 that also has the inverted U-shaped profile. Therefore, when the first magnetic core 1, the two second magnetic cores 2, and the two first electrical conductors 3, are assembled in the multi-phase inductor structure M1, the shape of the first recess 213 corresponds to the shape of the first body 31, so that the two first electrical conductors 3 can be respectively arranged and fixed in two of the first recesses 213. It should be noted that, a depth D of each of the two first recesses 213 is greater than or equal to a width W of each of the two first electrical conductors 3, so that the two first annular convex walls 211 and the two first upright convex walls 212 respectively of the two second magnetic cores 2 are correspondingly in contact with the two sides of the first magnetic cores 1 that are opposite to each other when the first magnetic core 1, the two second magnetic cores 2, and the two first electrical conductors are assembled in the multi-phase inductor structure M1.

In addition, each of the two second magnetic cores has a bottom surface 22, and the bottom surface 22 is flush with a bottom 212B of the first upright convex wall 212. The bottom surface 22 and each of two bottoms 211B respectively of two ends of the first annular convex wall 211 has a distance H therebetween, and the distance H is approximately equal to a thickness T of each of the two first pins 32. Accordingly, when the first magnetic core 1, the two magnetic cores 2, and the two first electrical conductors 3, are assembled in the multi-phase inductor structure M1, the first body 31 of each of the two first electrical conductors 3 is embedded in a corresponding one of the two recesses 213, and the two first pins 32 of each of the two first electrical conductors 3 are exposed from the multi-phase inductor structure M1 as shown in FIG. 2. In this way, the multi-phase inductor structure M1 can be coupled to a circuit board (not shown in the figures) through the two first pins 32 of each of the two first electrical conductors 3, so that the multi-phase inductor structure M1 can be electrically connected to electronic elements (not shown in the figures) on the circuit board.

### Second Embodiment

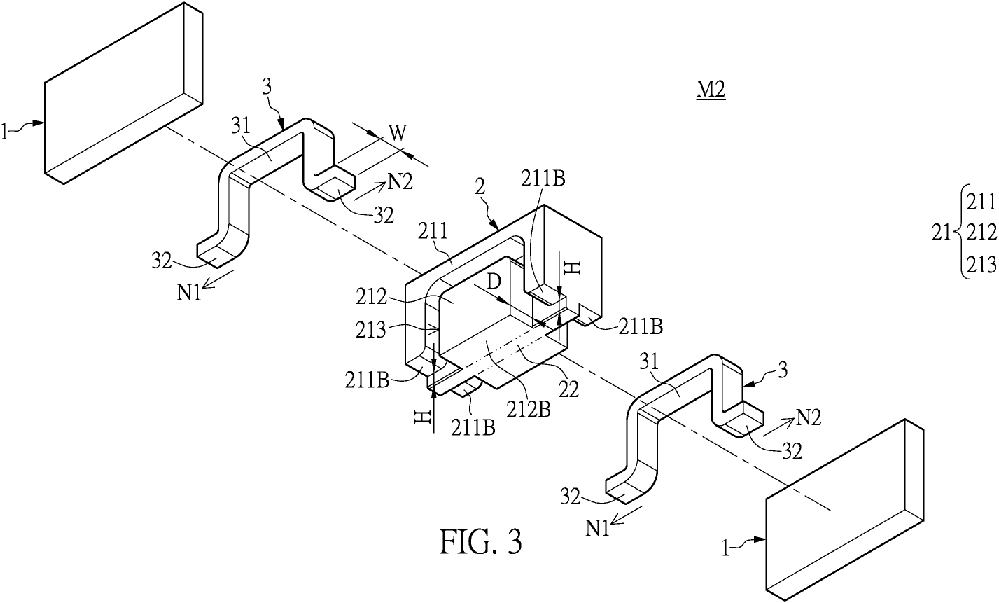

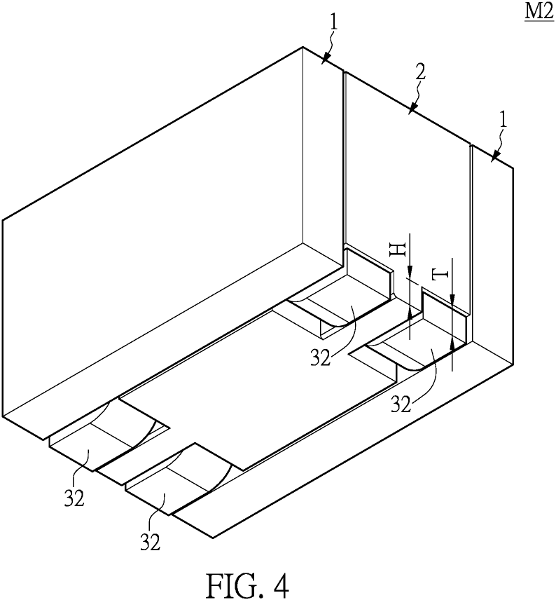

Referring to FIG. 3 and FIG. 4, FIG. 3 is a schematic exploded view of a multiple-phase inductor structure according to a second embodiment of the present disclosure, and FIG. 4 is a schematic perspective view of the multi-phase inductor structure according to the second embodiment of the present disclosure. The second embodiment of the present disclosure provides a multi-phase inductor structure M2, which includes two first magnetic cores 1, a second magnetic core 2, and two first electrical conductors 3. The second magnetic core 2 is arranged between the two first magnetic cores 1, and each of the two first electrical conductors 3 is arranged between the second magnetic core 2 and a corresponding one of the two first magnetic cores 1, that is, one of the two first electrical conductors 3 is arranged between the second magnetic core 2 and a left one of the two first magnetic cores 1, and another of the two first electrical conductors 3 is arranged between the second magnetic core 2 and a right one of the two first magnetic cores 1. The second magnetic core 2 has two first engagement surfaces 21 that are opposite to each other. When the two first magnetic cores 1, the second magnetic core 2, and the two first electrical conductors 3 are assembled in the multi-phase inductor structure M2, the two first engagement surfaces 21 of the second magnetic core 2 respectively come into contact with the two first magnetic cores 1. Further, each of the two first engagement surfaces 21 of the second magnetic core 2 has a first annular convex wall 211 and a first upright convex wall 212 formed thereon, and a first recess 213 is formed between the first annular convex wall 211 and the first upright convex wall 212. As shown in FIG. 3, the first annular convex wall 211 is arranged around the first upright convex wall 212, so that the first recess 213 formed between the first annular convex wall 211 and the first upright convex wall 212 has an inverted U-shaped profile.

According to the above, each of the two first electrical conductors 3 has a first body 31 and two first pins 32 that are respectively connected to two ends of the first body 31, and the two first pins 32 extend in opposite directions. Specifically, as shown in FIG. 3, the first body 31 is an inverted U-shaped structure that corresponds to the profile of the first recess 213, one of the two first pins 32 extends in a first direction N1, another of the two first pins 32 extends in a second direction N2, and the first direction N1 is opposite to the second direction N2. In this way, when the two first magnetic cores 1, the second magnetic core 2, and the two first electrical conductors 3, are assembled in the multi-phase inductor structure M2, the two first electrical conductors 3 can be respectively arranged in two of the first recesses 213. In addition, it should be noted that, a depth D of each of the two first recesses 213 is greater than or equal to a width W of each of the two first electrical conductors 3, so that the two first annular convex walls 211 and the two first upright convex walls 212 respectively of the two second magnetic cores 2 are correspondingly in contact with the two sides of the first magnetic cores 1 that are opposite to each other when the two first magnetic cores 1, the second magnetic core 2, and the two first electrical conductors, are assembled in the multi-phase inductor structure M2.

In addition, the depth D of each of the two first recesses 213 is greater than or equal to the width W of each of the two first electrical conductors 3. Accordingly, when the two first magnetic cores 1, the second magnetic core 2, and the two first electrical conductors 3, are assembled in the multi-phase inductor structure M2, the first body 31 of each of the two first electrical conductors 3 is embedded in a corresponding one of the two recesses 213, and the first annular convex wall 2111 and the first upright convex wall 212 of each of the two first engagement surfaces 21 of the second magnetic core 2 correspondingly come into contact with a corresponding one of the two first magnetic cores 1. Moreover, the second magnetic core 2 has a bottom surface 22, the bottom surface 22 is flush with a bottom 212B of the first upright convex wall 212 on each of the two first engagement surfaces 21, the bottom surface 22 and each of two bottoms 211B respectively of two ends of the first annular convex wall 211 has a distance H therebetween, and the distance H is approximately equal to a thickness T of each of the two first pins 32 of each of the two first electrical conductors 3. Accordingly, when the two first magnetic cores 1, the magnetic core 2, and the two first electrical conductors 3, are assembled in the multi-phase inductor structure M2, the two first pins of each of the two first electrical conductors 3 are exposed from the multi-phase inductor structure M2.

A magnetic permeability of each of the two first magnetic cores 1 is different from a magnetic permeability of the second magnetic core 2. For example, the first magnetic core 1 is made of a ferrite material, and the second magnetic core 2 is made of an alloy material. Alternatively, the first magnetic core 1 can be made of the alloy material, and the second magnetic core 2 is made of the ferrite material, but the present disclosure is not limited thereto.

Referring to FIG. 2 and FIG. 4, the multi-phase inductor M1 and the multi-phase inductor M2 of the present disclosure can each form a two-phase inductor, and an overall volume of each of the multi-phase inductor M1 and the multi-phase inductor M2 is reduced by more than 30% compared to conventional two-phase inductors formed by two independent single-phase inductors. Therefore, when the multi-phase inductor structure M1 or M2 is coupled to a circuit board, an unoccupied space can be increased due to a small size thereof.

### Third Embodiment

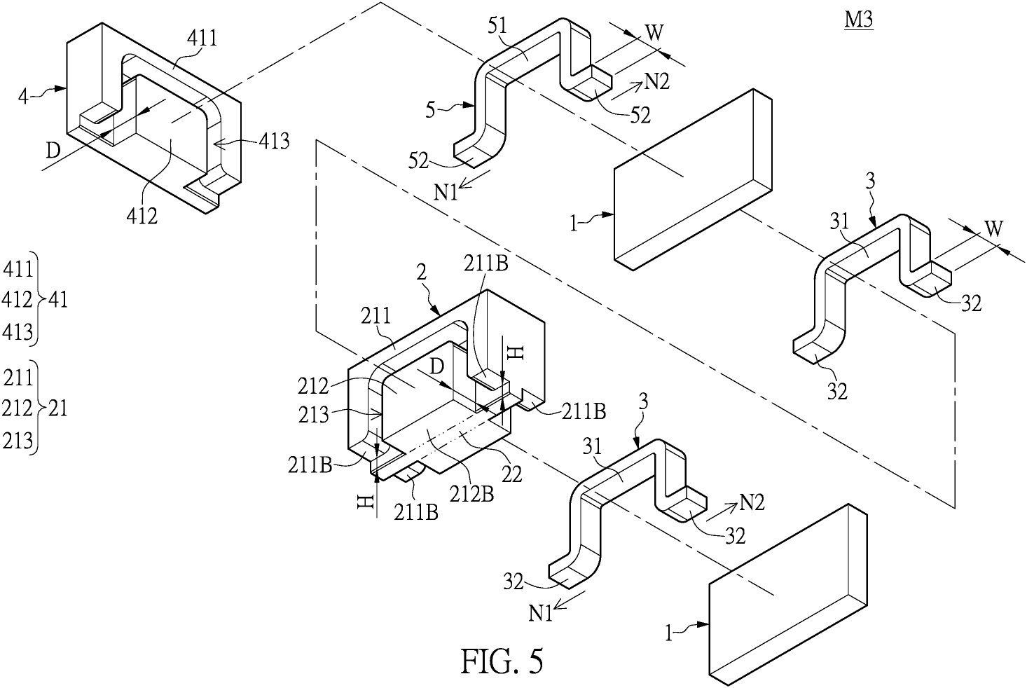

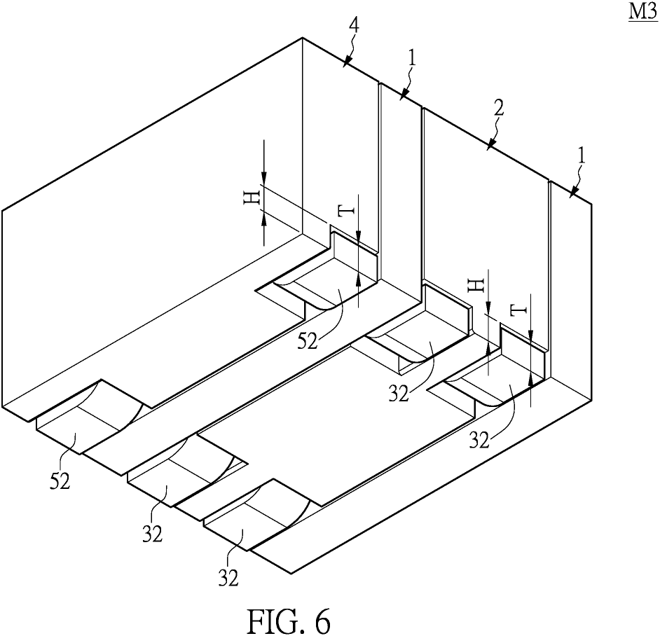

Referring to FIG. 5 and FIG. 6, FIG. 5 is a schematic exploded view of a multiple-phase inductor structure according to a third embodiment of the present disclosure, and FIG. 6 is a schematic perspective view of the multi-phase inductor structure according to the third embodiment of the present disclosure. The third embodiment of the present disclosure provides a multi-phase inductor structure M3, and a structure of the multi-phase inductor structure M3 is similar to that of the multi-phase inductor structure M2 of the second embodiment, and the similar structure is not reiterated herein. Specifically, comparing FIG. 3 and FIG. 4 respectively with FIG. 5 and FIG. 6, the multi-phase inductor structure M3 of the present embodiment further includes a third magnetic core 4 and a second electrical conductor 5 in comparison to that of the second embodiment. That is to say, the multi-phase inductor structure M3 can be regarded as an architecture of the multi-phase inductor structure M2 (i.e., two first magnetic cores 1, a second magnetic core 2, and two first electrical conductors 3) plus the third magnetic core 4 and the second electrical conductor 5. Referring to FIG. 4 and FIG. 6, the third magnetic core 4 and the second electrical conductor 5 are correspondingly arranged on one side of the architecture of the multi-phase inductor structure M2. The third magnetic core 4 has a second engagement surface 41, and the second engagement surface 41 contacts one of the two first magnetic cores 1. A second annular convex wall 411 and a second upright convex wall are formed on the second engagement surface 41, and a second recess 413 is formed between the second annular convex wall 411 and the second upright convex wall 412. The second electrical conductor 5 has a second body 51 and two second pins 52 that are respectively connected to two ends of the second body 51. A profile of the second recess 413 corresponds to a shape of the second body 51 of the second electrical conductor 5. Further, one of the two pins 52 of the second electrical conductor 5 extends in a first direction N1, and another of the two pins 52 of the second electrical conductor 5 extends in a second direction N2, that is, the two pins 52 extend in opposite directions.

In addition, a depth D of each of two first recesses 213 is greater than or equal to a width W of each of the two electrical conductors, and a depth D of the second recess 413 is greater than or equal to a width W of the second electrical conductor 5, i.e., the first recess 213 and the second recess 413 have the same depth D, and the first electrical conductor 3 and the second electrical conductor 5 have the same width W. Therefore, when the third magnetic core 4, the second electrical conductor 5, and the architecture of the multi-phase inductor structure M2 are assembled in the multi-phase inductor structure M3, the two first electrical conductors 3 can be respectively arranged in the two first recesses 213, and the second electrical conductor 5 is arranged between the third magnetic core 4 and the multi-phase inductor structure M2, and arranged in the second recess 413.

In addition, a bottom surface 22 of the second magnetic core 2 is flush with a bottom of each of two first upright convex walls 212, and the bottom surface 22 and a bottom of each of two ends of each of two first annular convex walls 211 have a distance H therebetween. The distance H is approximately equal to a thickness T of each of two first pins 32 of each of the two first electrical conductors 3. The third magnetic core 4 and the second electrical conductor 5 also has the same structural characteristics (as shown in FIG. 6, and is not reiterated herein). When the two first electrical conductors 3 are respectively arranged in the two first recesses 213, a first body 31 of each of the two first electrical conductors 3 is embedded in a corresponding one of the two recesses 213, and the two first pins 32 of each of the two first electrical conductors are exposed from the multi-phase inductor structure M3. Similarly, when the second body 51 of the second electrical conductor 5 is embedded in the corresponding second recess 413, the two second pins 52 are exposed from the multi-phase inductor structure M3.

In addition, a magnetic permeability of the third magnetic core 4 is different from a magnetic permeability of each of the two first magnetic cores 1. For example, the first magnetic core 1 is made of a ferrite material, the second magnetic core 2 and the third magnetic core 4 are correspondingly made of an alloy material, and the magnetic permeability of the first magnetic core 1 is correspondingly greater than the magnetic permeability of the second magnetic core 2 and the magnetic permeability of the third magnetic core 4. Alternatively, the first magnetic core 1 can be made of the alloy material, the second magnetic core 2 and the third magnetic core 4 are correspondingly made of the ferrite material, and the magnetic permeability of the first magnetic core 1 is correspondingly less than the magnetic permeability of the second magnetic core 2 and the magnetic permeability of the third magnetic core 4. Furthermore, the second electrical conductor 5 and the first electrical conductor 3 can be made of a same electrically conductive material.

Referring to FIG. 6, the multi-phase inductor M3 of the present disclosure can form a three-phase inductor, and an overall volume thereof is reduced by more than 30% compared to conventional three-phase inductors formed by three independent single-phase inductors. Therefore, when the multi-phase inductor structure M3 is coupled to a circuit board, an unoccupied space can be increased due to a small size thereof.

### Fourth Embodiment

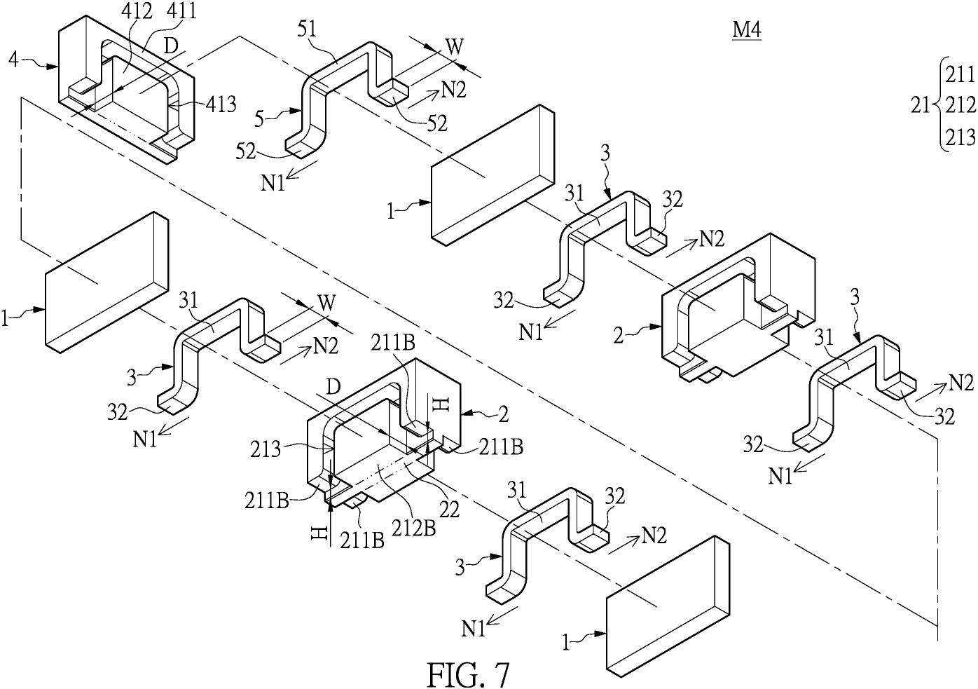

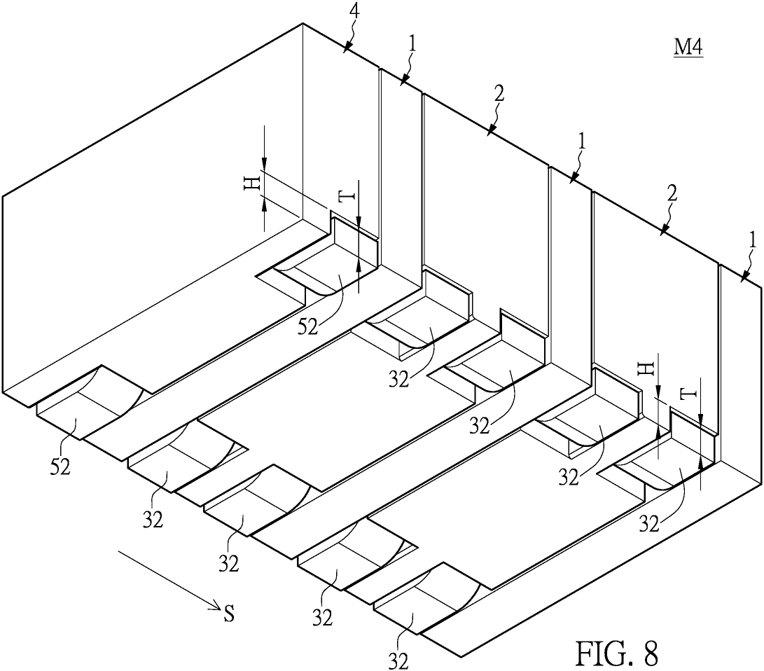

Referring to FIG. 7 and FIG. 8, FIG. 7 is a schematic exploded view of a multiple-phase inductor structure according to a fourth embodiment of the present disclosure, and FIG. 8 is a schematic perspective view of the multi-phase inductor structure according to the fourth embodiment of the present disclosure. The fourth embodiment of the present disclosure provides a multi-phase inductor structure M4, which includes a plurality of first magnetic cores 1, a plurality of second magnetic cores 2, a third magnetic core 4, and a plurality of electrical conductors including a plurality of first electrical conductors 3 and a second electrical conductor 5. Each of the plurality of electrical conductors has a body (i.e., a first body 31 or a second body 51) and two pins (i.e., two first pins 32 or two second pins 52) that are connected to two ends of the body. Comparing FIG. 6, and FIG. 8, the multi-phase inductor structure M4 of the present embodiment has a similar structure and is made of similar materials as those of the multi-phase inductor structure M3 provided by the third embodiment, and the similar structure is not reiterated herein. Specifically, the multi-phase inductor structure M4 can be regarded as an architecture of the multi-phase inductor structure M3 plus a second magnetic core 2, two first electrical conductors 3, and a first magnetic core 1, so as to add one more two-phase inductor. It should be noted that, the present disclosure is not limited to the multi-phase inductor structures M1 to M4 of the first to fourth embodiments. For example, in the present disclosure, multiple ones of the two-phase inductors can be added into the multi-phase inductor structure M4 (i.e. each additional two-phase inductor added into the multi-phase inductor structure M4 results in an additional one of the second magnetic core 2, two additional ones of the first electrical conductors 3, and an additional one of the first magnetic core 1 to be included in the multi-phase inductor structure M4). The multi-phase inductor M4 of the present disclosure can form a five-phase inductor, and an overall volume thereof is reduced by more than 30% compared to conventional five-phase inductors formed by five independent single-phase inductors. Therefore, when the multi-phase inductor structure M4 is coupled to a circuit board, an unoccupied space can be increased due to a small size thereof.

### Beneficial Effects of the Embodiments

In conclusion, one of the beneficial effects of the present disclosure is that, in the multi-phase inductor structure provided by the present disclosure, by virtue of “the plurality of first magnetic cores and the plurality of second magnetic cores are staggeringly arranged with each other” and “the magnetic permeability of the first magnetic core being different from the magnetic permeability of the second magnetic core,” the multi-phase inductor structure can have a miniaturized design with high power, and a capacitance value and current capability of the multi-phase inductor structure can be increased.

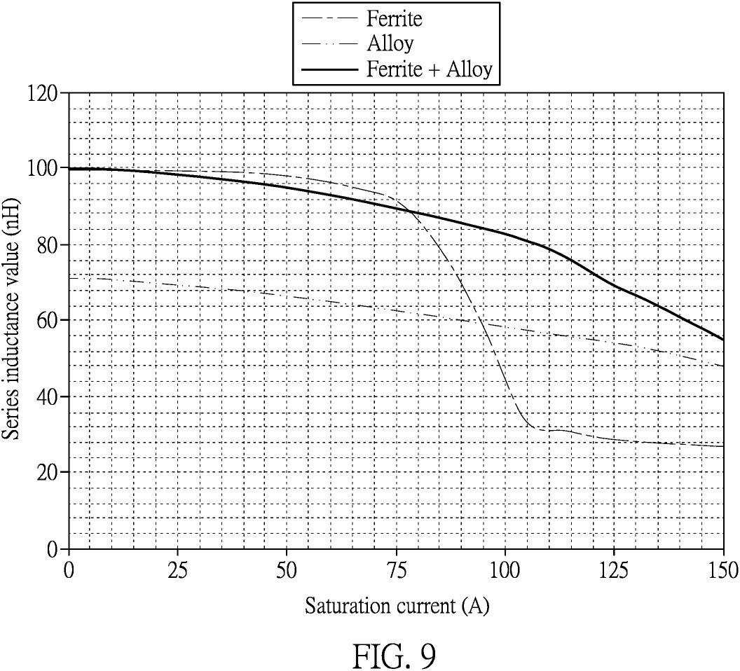

According to the above, in the present disclosure, multiple composite materials are arranged in a staggered manner (i.e., the same materials do not contact each other) to form the multi-phase inductor structure, so that a high inductance value and high saturation current of the multi-phase inductor structure can be achieved simultaneously. Referring to FIG. 9, FIG. 9 is a characteristic curve diagram of the multi-phase inductor structure according to the present disclosure. As shown in FIG. 9, the high inductance value and the high saturation current cannot be simultaneously achieved in a same-sized inductor structure which is made of a single material. Taking an inductor structure made of the ferrite material as the single material as an example. The inductor structure made of the ferrite material has the high inductance value (e.g., above 90 nH), while simultaneously, the saturation current thereof can be maintained at a maximum of 75 A. In other words, when the saturation current thereof is more than 100 A, the inductance value thereof is decreased to less than 40 nH. Alternatively, taking an inductor structure made of the alloy material as the single material as an example. The inductor structure made of the alloy material has the high saturation current (e.g., above 100 A), while simultaneously, the inductance value thereof can be maintained at a maximum of 60 nH. In contrast, in the multi-phase inductor structure provided by the present disclosure, which is made of a composite material (i.e., including the ferrite material and the alloy material simultaneously), the high inductance value and the high saturation current can be achieved simultaneously. When the saturation current of the multi-phase inductor structure provided by the present disclosure is 100 A, the inductance value can be maintained more than 80 nH.

Further, each of the multi-phase inductor structures M1 to M4 respectively of the first to fourth embodiments of the present disclosure form a multi-phase inductor, and the overall volume of each of the multi-phase inductor structures M1 to M4 is reduced by more than 30% compared to conventional multi-phase inductors formed by multiple independent single-phase inductors. Therefore, when each of the multi-phase inductor structures M1 to M4 is coupled to the circuit board, the unoccupied space can be increased due to the small size thereof.

Furthermore, referring to FIG. 2, FIG. 4, FIG. 6, and FIG. 8, in the present disclosure, the multi-phase inductor structure M4 is formed by staggeringly arranging multiple composite materials (i.e., the ferrite material and the alloy material) therein, and the pins of the plurality of electrical conductors of the multi-phase inductor structure M4 (including the plurality of first electrical conductors 3 and the second electrical conductor 5) are arranged in a stacking direction S (i.e., a direction along which the multiple composite materials are stacked) on two edges of a bottom of the multi-phase inductor structure M4 (i.e., a bottom surface of the multi-phase inductor structure M4 for coupling to the circuit board) as exemplarily shown in FIG. 8. In addition, multiple ones of the pins are not close to each other, where two adjacent first electrical conductors 3 are separated by at least one first magnetic core 1 or at least one second magnetic core 2, and the first electrical conductor 3 and an adjacent one of the second electrical conductor 5 are separated by at least one first magnetic core 1. Therefore, compared to the conventional multi-phase inductor structures easily having closely arranged pins on areas of the bottom that are away from outer edges of the bottom (i.e., the pins are concentrated near a center of the bottom, which results in a difficulty to find the pins when the pins are coupled to the circuit board, thereby increasing a difficulty of coupling), the difficulty of coupling the pins to the circuit board can be effectively reduced when the multi-phase inductor structure M4 of the present disclosure is coupled to the circuit board.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A multi-phase inductor structure, comprising:
a first magnetic core;
two second magnetic cores respectively arranged on two sides of the first magnetic core that are opposite to each other, wherein each of the two second magnetic cores has a first engagement surface, the first engagement surface of each of the two second magnetic cores has a first annular convex wall and a first upright convex wall formed thereon, and a first recess is formed between the first annular convex wall and the first upright convex wall; and
two first electrical conductors respectively arranged in two of the first recesses of the first engagement surface, wherein each of the two first electrical conductors has a first body and two first pins that are respectively connected to two ends of the first body, and the two first pins extend in opposite directions;
wherein a magnetic permeability of the first magnetic core is different from a magnetic permeability of each of the two second magnetic cores.

2. The multi-phase inductor structure according to claim 1, wherein the first magnetic core is made of a ferrite material, each of the two second magnetic core is made of an alloy material, and the magnetic permeability of the first magnetic core is greater than the magnetic permeability of each of the two second magnetic cores.

3. The multi-phase inductor structure according to claim 1, wherein the first magnetic core is made of an alloy material, each of the two second magnetic core is made of a ferrite material, and the magnetic permeability of the first magnetic core is less than the magnetic permeability of each of the two second magnetic cores.

4. The multi-phase inductor structure according to claim 1, wherein a bottom surface of each of the two second magnetic cores is flush with a bottom of the first upright convex wall, and a distance is defined between the bottom surface of each of the two second magnetic cores and a bottom of each of two ends of the first annular convex wall.

5. The multi-phase inductor structure according to claim 4, wherein, when the two first electrical conductors are respectively arranged in two of the first recesses, the first body of each of the two first electrical conductors is embedded in a corresponding one of the first recess, and the two first pins of each of the two first electrical conductors are exposed from the multi-phase inductor structure.

6. The multi-phase inductor structure according to claim 1, wherein a depth of the first recess is greater than or equal to a width of each of the two first electrical conductors.

7. A multi-phase inductor structure, comprising:
two first magnetic cores;
a second magnetic core arranged between the two first magnetic cores, wherein the second magnetic core has two first engagement surfaces that are opposite to each other, each of the two first engagement surfaces has a first annular convex wall and a first upright convex wall formed thereon, and a first recess is formed between the first annular convex wall and the first upright convex wall; and
two first electrical conductors respectively arranged in two of the first recesses of the first engagement surface, wherein each of the two first electrical conductors has a first body and two first pins that are respectively connected to two ends of the first body, and the two first pins extend in opposite directions;
wherein a magnetic permeability of each of the two first magnetic cores is different from a magnetic permeability of the second magnetic core.

8. The multi-phase inductor structure according to claim 7, further comprising:
a third magnetic core; and
a second electrical conductor;
wherein the third magnet core has a second engagement surface, the second engagement surface has a second annular convex wall and a second upright convex wall formed thereon, a second recess is formed between the second annular convex wall and the second upright convex wall, and the second electrical conductor is arranged in the second recess;
wherein the second electrical conductor has a second body and two second pins that are respectively connected to two ends of the second body, and the two second pins extend in opposite directions;
wherein a magnetic permeability of the third magnetic core is different from the magnetic permeability of each of the two first magnetic cores.

9. The multi-phase inductor structure according to claim 8, wherein each of the two first magnetic cores is made of a ferrite material, each of the second magnetic core and the third magnetic core is made of an alloy material, and the magnetic permeability of each of the two first magnetic cores is correspondingly greater than the magnetic permeability of the second magnetic core and the magnetic permeability of the third magnetic core.

10. The multi-phase inductor structure according to claim 8, wherein each of the two first magnetic cores is made of an alloy material, each of the second magnetic core and the third magnetic core is made of a ferrite material, and the magnetic permeability of each of the two first magnetic cores is correspondingly less than the magnetic permeability of the second magnetic core and the magnetic permeability of the third magnetic core.

11. The multi-phase inductor structure according to claim 8, wherein a bottom surface of the second magnetic core is flush with a bottom of each of two of the first upright convex walls, and a distance is defined between the bottom surface of the second magnetic core and a bottom of each of two ends of each of two of the first annular convex walls.

12. The multi-phase inductor structure according to claim 11, wherein, when the two first electrical conductors are respectively arranged in two of the first recesses, the first body of each of the two first electrical conductors is embedded in a corresponding one of the first recess, and the two first pins of each of the two first electrical conductors are exposed from the multi-phase inductor structure.

13. The multi-phase inductor structure according to claim 11, wherein, when the second electrical conductor is arranged in the second recess, the second body of the second electrical conductor is embedded in the second recess, and the two second pins are exposed from the multi-phase inductor structure.

14. The multi-phase inductor structure according to claim 8, wherein a depth of the first recess is greater than or equal to a width of each of the two first electrical conductors, and a depth of the second recess is greater than or equal to a width of the second electrical conductor.

15. A multi-phase inductor structure, comprising:
a plurality of first magnetic cores;
a plurality of second magnetic cores arranged staggeringly with the plurality of first magnetic cores, wherein each of the plurality of second magnetic cores is arranged between two of the plurality of first magnetic cores that are adjacent to each other, each of the plurality of second magnetic cores has two first engagement surfaces that are opposite to each other, each of the two first engagement surfaces has a first annular convex wall and a first upright convex wall, and a first recess is formed between the first annular convex wall and the first upright convex wall;
a third magnetic core in contact with one of two outermost first magnetic cores, wherein the third magnetic core has a second engagement surface, the second engagement surface has a second annular convex wall and a second upright convex wall formed thereon, and a second recess is formed between the second annular convex wall and the second upright convex wall; and
a plurality of electrical conductors correspondingly arranged in multiple ones of the first recesses of the first engagement surface and the second recess, wherein each of the plurality of electrical conductors has a body and two pins that are respectively connected to two ends of the body, and the two pins extend in opposite directions;
wherein a magnetic permeability of each of the plurality of first magnetic cores is correspondingly different from a magnetic permeability of each of the plurality of second magnetic cores and a magnetic permeability of the third magnetic core.
